(19) United States
(12) Patent Application Publication
(10) Pub. No.: US 2015/0348579 A1
(43) Pub. Date: Dec. 3, 2015

(54) MAGNETIC RECORDING MEDIUM AND METHOD FOR MANUFACTURING THE SAME

(71) Applicant: CANON ANELVA CORPORATION, Kawasaki-shi, Kanagawa (JP)

(72) Inventors: Hidetomo NARADATE, Kawasaki-shi, Kanagawa (JP); Akio SATO, Kawasaki-shi, Kanagawa (JP); Masahiro SHIBAMOTO, Kawasaki-shi, Kanagawa (JP); Kazuto YAMANAKA, Kawasaki-shi, Kanagawa (JP)

(73) Assignee: CANON ANELVA CORPORATION, Kawasaki-shi, Kanagawa (JP)

(21) Appl. No.: 14/655,226

(22) PCT Filed: Dec. 18, 2013
(86) PCT No.: PCT/JP2013/083830

§ 371 Date: Jun. 24, 2015

(30) Foreign Application Priority Data
Dec. 27, 2012 (JP) 2012-284686

(51) Int. Cl. G11B 5/73; G11B 5/667; G11B 5/84

(52) U.S. Cl. CPC G11B 5/7325; G11B 5/84; G11B 5/667

(57) ABSTRACT

A magnetic recording medium having high coercivity, in which an L1₀-type ordered alloy with a high magnetic anisotropy is used in a magnetic recording layer, and a method for manufacturing the magnetic recording medium at high throughput are provided. By providing a metal base layer having a face-centered cubic structure below an orientation control layer which is for enhancing crystallinity of the magnetic recording layer that contains the ordered alloy having an L1₀-type structure, the magnetic recording layer that has enough high coercivity even in the case of reducing a thickness of the orientation control layer can be deposited, and the thickness of the orientation control layer that is mainly made of oxide can be reduced, whereby the throughput can be improved.

### TECHNICAL FIELD

The present invention relates to a magnetic recording medium that is mounted on various kinds of magnetic recording apparatuses and a method for manufacturing the same.

### BACKGROUND ART

As a technique of realizing densification of magnetic recording, a vertical magnetic recording system is adopted. As a material for forming a magnetic recording layer of a vertical magnetic recording medium, for example, a granular magnetic film is used.

Recently, it has been necessary to reduce a grain size of a magnetic crystal grain in a magnetic film so as to further increase a recording density of a vertical magnetic recording medium. On the other hand, such reduction of the grain size of the magnetic crystal grain leads to deterioration of thermal stability of recorded magnetization. Therefore, in order to compensate the deterioration of the thermal stability due to such reduction of the grain size of the magnetic crystal grain, it has been sought to form the magnetic crystal grain in the magnetic film by using a material with a higher crystal magnetic anisotropy.

As the thus sought material having such a higher crystal magnetic anisotropy, L1₀-type FePt, L1₀-type CoPt, and the like having L1₀-type structures that are superior in preservation stability of information and have high crystal magnetic anisotropies have drawn attention. For making the L1₀-type FePt have a high magnetic anisotropy, a [001] axis of an L1₀-type FePt film is necessary to be oriented perpendicularly to a film surface thereof.

Whereas, in a magnetic recording medium, a substrate made of aluminum or glass is used in the light of strength, shock resistance, and the like. In the case of forming an L1₀-type ordered alloy film that has the L1₀-type structure on a surface of such the substrate, a crystal of the L1₀-type ordered alloy is necessary to be subjected to (001) orientation in order to have the high crystal magnetic anisotropy. Therefore, as a base layer for an L1₀-type ordered alloy film, an orientation control layer having an NaCl structure or a CsCl structure for enhancing the crystal orientation of the L1₀-type ordered alloy is generally provided. In particular, an MgO film having the NaCl structure exhibits a high lattice matching property to the L1₀-type ordered alloy, and thus has been broadly used as the orientation control layer.

As a result of experiments so far, it has been realized that, in the case of using the MgO film as the base layer for the L1₀-type FePt film for obtaining the magnetic properties, a film thickness thereof is required to be within a range of 10 nm to 20 nm. However, the MgO target is an insulator, and thus is necessary to be deposited by an RF sputtering method, and a film deposition rate in this case is significantly low as about 0.1 nm/s. Also, even in the case of depositing the film by a reactive sputtering method in a mixed atmosphere of Ar gas and O₂ gas using an Mg target, a film deposition rate thereof is, at most, about twice as high as that in the case of the RF sputtering method using the MgO target.

In a usual mass production process of magnetic recording media, it is desired to reduce a film deposition time of each layer as much as possible and equalize the deposition times of the respective layers, in the light of the throughput. In the case of depositing an MgO film with a film thickness of 10 nm to 20 nm at the above-described sputter rate, depositing the MgO film requires a long period of time, thereby lowering the throughput significantly. Therefore, it is expected to further reduce the film thickness of the MgO film for obtaining the desired coercivity.

Patent Literature 1 discloses a technique of depositing an MgO film that exhibits excellent orientation controllability to L1₀-type ordered alloy even with a film thickness of 3 nm or less, by providing a layer of a cubic-system conductive compound such as strontium titanate, indium tin oxide and titanium nitride as a base layer for the MgO film.

### PRIOR ART REFERENCE

### Patent Literature

### Patent Literature 1: Japanese Patent Application Laid-Open No. 2012-174320

### SUMMARY OF THE INVENTION

### Problem to be Solved by the Invention

In a magnetic recording medium disclosed in Patent Literature 1, a conductive compound layer that is a base layer for an MgO film is deposited not by an RF sputtering method, whose film deposition rate is low, but a DC sputtering method, and in this case, the conductive compound layer is deposited by a reactive sputtering method while introducing reactive gas such as oxygen gas and nitrogen gas.

However, in the reactive sputtering method, control of a minute amount such as several % of the reactive gas is not easy, and thus, there has been a problem of the reproducibility of the film deposition. In addition, the reactive sputtering method has a problem that it takes time after the introduction of the reactive gas until a film deposition atmosphere becomes stable.

The present invention aims to solve the above-described problems, and aims to provide a magnetic recording medium having high coercivity, in which an L1₀-type ordered alloy with a high magnetic anisotropy is used in a magnetic recording layer, and a method for manufacturing the magnetic recording medium at high throughput with high reproducibility.

### Means for Solving the Problem

The magnetic recording medium of the present invention for solving the above-described problems includes a metal base layer, an orientation control layer that is deposited on the metal base layer, and a magnetic recording layer made of ordered alloy having an L1₀-type structure that is deposited on the orientation control layer, wherein the metal base layer has a face-centered cubic structure.

Further, the method for manufacturing the magnetic recording medium of the present invention includes depositing a metal base layer on a substrate, depositing an orientation control layer on the metal base layer, and depositing a magnetic recording layer that is made of ordered alloy having an L1₀-type structure on the orientation control layer, wherein the metal base layer has a face-centered cubic structure.

### Effects of the Invention

In the present invention, according to the structure employing the metal base layer that can be deposited in a short period of time with high reproducibility as a base layer for the orientation control layer, even if a film thickness of the orientation control layer is reduced, the magnetic recording layer that is made of the L1₀-type ordered alloy having a high crystal magnetic anisotropy can be deposited, whereby the magnetic recording medium having high retentivity can be manufactured at high throughput with high reproducibility.

### BRIEF DESCRIPTION OF THE DRAWINGS

FIG. 1 is a plan view illustrating a schematic structure of an apparatus for manufacturing a magnetic recording medium that is preferably used in the present invention.

FIG. 2 is a cross-sectional view schematically illustrating a structure of a magnetic recording medium of an example of the present invention.

### MODE FOR CARRYING OUT THE INVENTION

Embodiments of the present invention will be described below in detail with reference to the accompanying drawings. Incidentally, the present invention is not limited to the below-described embodiments, and can be modified as appropriate without departing from the gist of the invention.

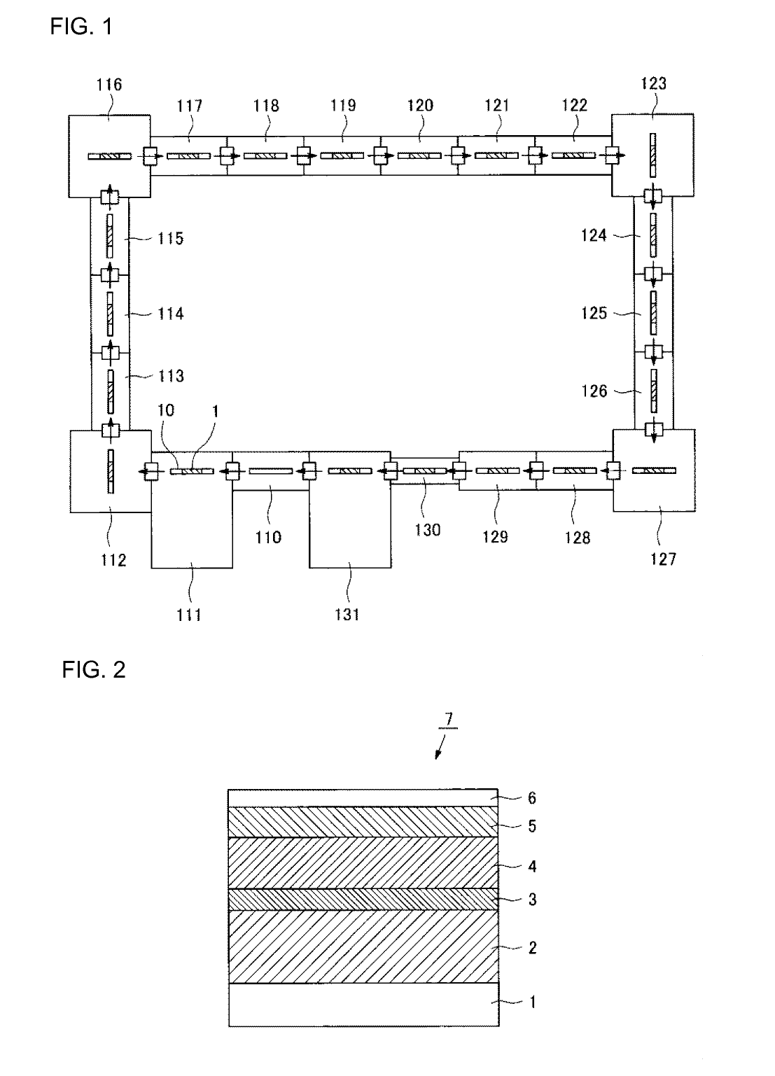

FIG. 1 is a plan view illustrating an apparatus for manufacturing a magnetic recording medium that is preferably used in the present invention. The manufacturing apparatus of FIG. 1 is an in-line type film deposition apparatus. The in-line type means an apparatus in type that a substrate is carried via plural connected chambers. In the film deposition apparatus of FIG. 1, plural chambers 110 to 131 are connected via gate valves along a rectangle outline in an endless state. A substrate 1 is mounted on a carrier 10 in a load lock chamber 111; the carrier 10 passes through the respective chambers 112 to 130 in this order; and the substrate 1 is collected in an unload lock chamber 131. Each of the chambers 111 to 131 is a vacuum vessel that is exhausted by an exhaust system for its exclusive use or for multi-use.

The chambers 112, 116, 123 and 127 are direction turning chambers each of which is provided with a direction turning mechanism for turning a direction of carrying the carrier 10 by 90 degrees. The respective chambers 113 to 130 except for the chambers 116, 123 and 127 are processing chambers that carry out various kinds of processes. More specifically, the chambers include a soft magnetic layer deposition chamber 114 that forms a soft magnetic layer on the substrate 1, a metal base layer deposition chamber 115 that forms a metal base layer on the substrate 1 on which the soft magnetic layer is deposited, an orientation control layer deposition chamber 118 that forms an orientation control layer on the substrate 1 on which the metal base layer is deposited, a magnetic recording layer deposition chamber 124 that forms a magnetic recording layer on the substrate 1 on which the orientation control layer is deposited, a substrate heating chamber 125 having a mechanism that heats the substrate 1 on which the magnetic recording layer is deposited, and a protection layer deposition chamber 129 that forms a protection layer above the magnetic recording layer. Other processing chambers include a substrate cooling chamber that cools the substrate 1, a substrate reholding chamber that reholds the substrate 1, and the like. In the chamber 110, the carrier 10 is processed after exporting the substrate 1.

In the present embodiment, the film deposition process to the substrate 1 is carried out by a sputtering (hereinafter, also called as sputter) method. A sputtering chamber is mainly provided with an exhaust system, a gas introduction system that introduces process gas, a target that is provided so as to expose a surface to be sputtered in an internal space, a power supply that applies discharging voltage, and a magnet mechanism that is provided behind the target.

Each of the processing chambers is configured bilaterally symmetrically to the carrier 10 (the substrate 1), and is provided with a structure of enabling film deposition onto both surfaces of the substrate 1 that is held in the carrier 10 at the same time. Inside of a film deposition chamber is kept at a predetermined pressure by the exhaust system while process gas is introduced therein, and in this state, the power supply that is connected to a target holder is operated. As a result, discharge is caused near the target so as to sputter the target, and the sputtered target material reaches the substrate 1, thereby depositing a predetermined film on the surface of the substrate 1. Incidentally, an RF power supply is used as the sputtering power supply only in the orientation control layer deposition chamber 118, and DC power supplies are used in other film deposition chambers.

FIG. 2 is a view illustrating a cross-sectional structure of a magnetic recording medium 7 according to the present invention. In the magnetic recording medium 7, a soft magnetic layer 2, a metal base layer 3, an orientation control layer 4, a magnetic recording layer 5, and a protection layer 6 are deposited on the substrate 1 in this order. Incidentally, the present invention is not limited to this embodiment, and the magnetic recording medium 7 can be used by further adding or superimposing a layer made of another material between the substrate 1 and the soft magnetic layer 2, between the soft magnetic layer 2 and the metal base layer 3, or on the magnetic recording layer 5.

As a material of the substrate 1, a nonmagnetic rigid substrate which is made of soda-lime glass, chemically strengthened aluminosilicate, an Al—Mg alloy substrate on which nickel phosphorus is nonelectrolytically plated, silicon, ceramics made of borosilicate glass or the like, glass-glazed ceramics, or the like can be used.

As a material of the soft magnetic layer 2, FeCo alloy, FeTa alloy, Co alloy, or the like can be used. A material of the protection layer 6 is, for example, diamond-like carbon, carbon nitride, silicon nitride, or the like.

The metal base layer 3 is selected from a group of metals having face-centered cubic structures. More specifically, the metal base layer 3 is selected from Ag, Al, Au, Cu, Ir, Ni, Pt, Pd, and Rh that have the face-centered cubic structures. Alternatively, the metal base layer 3 is made of alloy having the face-centered cubic structure which contains at least one kind selected from them.

The above-described material group of the metal base layer 3 has the face-centered cubic structure under normal temperature and normal pressure, and a lattice constant thereof ranges from about 0.353 nm to about 0.410 nm, thereby exhibiting an excellent lattice matching property with a and b axis lengths of 0.385 nm of the L1₀-type ordered alloy.

The metal base layer 3 of the present invention can be deposited by the DC sputtering method with the high film deposition rate, and the introduction of the reactive gas is not necessary, so that the metal base layer 3 with a required film thickness can be deposited in a short period of time with high reproducibility.

The orientation control layer 4 is used for improving crystallinity of the L1₀-type ordered alloy. An NaCl-type crystal with (100) orientation, a CsCl-type crystal with (100) orientation, an intermetallic compound having an L1₀-type structure with (001) orientation, an intermetallic compound having an L1₂-type structure with (001) orientation, or the like is used. In particular, MgO having an NaCl structure which exhibits an excellent lattice matching property with the L1₀-type ordered alloy is preferably used.

In the case of using the MgO film as the orientation control layer 4, an element other than the MgO can be contained as far as the NaCl structure of the MgO can be maintained. Examples of the element to be added to the MgO include a metal element with a melting point of 2000 degrees C. or more, which has at least one element selected from the group containing Nb, Mo, Ru, Ta, W, and the like. By adding such a metal element, a grain size of the MgO film can be minimized.

For the magnetic recording layer 5, an L1₀-type ordered alloy is used. In particular, L1₀-type FePt ordered alloy or L1₀-type CoPt ordered alloy is desirably used. Further, for promoting ordering of the L1₀-type FePt ordered alloy, a third element such as Ag, Au, or Cu may be added into the magnetic recording layer. Moreover, for obtaining a structure that is preferred as the magnetic recording layer (a granular structure) in which minute magnetic crystal particles are isolated from each other on a crystal grain boundary, as a material to segregate the magnetic crystal particles to the grain boundary, an oxide such as SiO₂, TiO₂, and MgO, or a carbon-based nonmetallic element can be added into the magnetic recording layer 5.

### EXAMPLES

### Example 1

A magnetic recording medium 7 with a laminate structure illustrated in FIG. 1 was manufactured. Firstly, a CoTaZr film with a film thickness of 40 nm was deposited as a soft magnetic layer 2 on a glass substrate 1, and a Pd film with a film thickness of 3 nm was deposited as a metal base layer 3. The metal base layer 3 was deposited by a DC sputtering method in an Ar atmosphere at pressure of 0.6 Pa. An orientation control layer 4 that was made of an MgO film with a film thickness of 20 nm, and an Fe film with a film thickness of 3 nm and a Pt film with a film thickness of 3 nm that compose a magnetic recording layer 5 were laminated one by one on the metal base layer 3, and a carbon film with a film thickness of 3 nm was sequentially deposited as a protection layer 6 thereon. Further, after the deposition of the magnetic recording layer 5, the substrate was heated at about 500 degrees C., whereby the Fe film and the Pt film that were laminated as the magnetic recording layer 5 were converted into an L1₀-type FePt ordered alloy film.

In the present example, as the magnetic recording layer 5, the Fe film and the Pt film were laminated one by one and were subsequently heated so as to be converted into the L1₀-type FePt ordered alloy film, but the L1₀-type FePt ordered alloy film may be deposited by performing sputtering by using an alloy target of Fe and Pt or performing cosputtering by using individual targets of Fe and Pt respectively, and subsequently heating.

### Example 2

In Example 2, the magnetic recording medium 7 was manufactured in the same method as Example 1 under the same film deposition conditions including the film thicknesses of the respective layers except for the orientation control layer 4, which was deposited to have the film thickness of 5 nm.

### Example 3

In Example 3, the magnetic recording medium 7 was manufactured in the same method as Example 1 under the same film deposition conditions including the film thicknesses of the respective layers except for the metal base layer 3, which was deposited to have the film thickness of 10 nm.

### Comparative Example 1

In Comparative example 1, the magnetic recording medium 7 was manufactured in the same method as Example 1 under the same film deposition conditions including the film thicknesses of the respective layers, except that the metal base layer 3 was not deposited.

### Comparative Example 2

In Comparative example 2, the magnetic recording medium 7 was manufactured in the same method as Example 2, except that a Cr film having a body-centered cubic structure was deposited to have a thickness of 10 nm, instead of the Pd film having the face-centered cubic structure, as the metal base layer 3.

In Table 1, the film thicknesses of the orientation control layer 4 of the magnetic recording medium 7, the materials and the film thicknesses of the metal base layer 3, and coercivity of the magnetic recording medium 7 of Examples 1 to 3, and Comparative examples of 1 and 2 will be shown. The coercivity was measured by BH-800UVHD, polar Kerr effect measuring equipment produced by NEOARK Corporation.

TABLE 1

| | Film Thickness | Material/Film | |
|---|---|---|---|
| | of Orientation | Thickness of | Coercivity |
| | Control Layer | Metal Base Layer | (Oe) |
| Example1 | 20 nm | Pd 3 nm | 8927 |
| Example2 | 5 nm | Pd 3 nm | 7100 |
| Example3 | 20 nm | Pd 10 nm | 8333 |
| Comparative | 20 nm | none | 5300 |
| Example1 | | | |
| Comparative | 20 nm | Cr 10 nm | 2910 |
| Example2 | | | |

The coercivity of the magnetic recording medium of Example 1 was 8927 Oe, exhibiting a higher value than the coercivity of the magnetic recording medium of Comparative example 1 of 5300 Oe, which has no Pd film as the metal base layer 3.

Also, the coercivity of the magnetic recording medium 7 of Example 2, in which the film thickness of the orientation control layer 4 was made as thin as 5 nm, maintained a high value as 7100 Oe. This value is higher than that of Comparative example 1 in which the Pd film was not deposited and the film thickness of the MgO film was 20 nm. Accordingly, it can be realized that, by depositing the Pd film as the metal base layer 3, the magnetic recording medium 7 could obtain the sufficiently high coercivity, even if the film thickness of the MgO film was made thin.

Also in Example 3 in which the film thickness of the Pd film was made as thick as 10 nm, the coercivity was 8333 Oe. Even if the film thickness of the Pd film was made thick, the coercivity maintained to have a high value.

In Comparative Example 2 in which the Cr film with the body-centered cubic structure was deposited to have the thickness of 10 nm as the metal base layer 3, the coercivity was 2910 Oe, which was smaller than that of Comparative example 1 in which the metal base layer 3 was not deposited. As a reason why the coercivity was reduced significantly, it can be considered that the Cr was diffused into the magnetic recording layer 5. This is because such metal having the body-centered cubic structure represented by Cr deteriorates ferromagnetic of a 3d ferromagnetic element significantly. On the other hand, the metal such as Pd having the face-centered cubic structure does not deteriorate the magnetic properties of such a 3d ferromagnetic element significantly.

In the case of reducing the thickness of the orientation control layer 4 by using the metal base layer 3, possibility that the atoms composing the metal base layer 3 transmit the orientation control layer 4 and are diffused in the magnetic recording layer 5 is increased, but by using the metal base layer 3 that has the face-centered cubic structure, the deterioration of the magnetic properties of the magnetic recording layer 5 can be suppressed, even in the case where the atoms composing the metal base layer 3 are diffused in the magnetic recording layer 5.

### EXPLANATION OF REFERENCE

1 substrate
2 soft magnetic layer
3 metal base layer
4 orientation control layer
5 magnetic recording layer
6 protection layer
7 magnetic recording medium
10 carrier
111 load lock chamber
112, 116, 123, 127 direction turning chamber
114 soft magnetic layer deposition chamber
115 metal base layer deposition chamber
118 orientation control layer deposition chamber
124 magnetic recording layer deposition chamber
125 substrate heating chamber
129 protection layer deposition chamber
131 unload lock chamber

1. A magnetic recording medium comprising:
a soft magnetic layer;
a metal base layer that is deposited on the soft magnetic layer;
an orientation control layer that is deposited on the metal base layer so as to contact with the metal base layer; and
a magnetic recording layer made of ordered alloy having an L1₀-type structure that is deposited on the orientation control layer so as to contact with the orientation control layer, wherein
the metal base layer has a face-centered cubic structure.

2. The magnetic recording medium according to claim 1, wherein the metal base layer is structured using one selected from Ag, Al, Au, Cu, Ir, Ni, Pt, Pd, and Rh, or alloy containing one or more selected from them.

3. The magnetic recording medium according to claim 1, wherein a main component of the orientation control layer is MgO.

4. A method for manufacturing a magnetic recording medium comprising:
depositing a soft magnetic layer on a substrate;
depositing a metal base layer on the soft magnetic layer;
depositing an orientation control layer on the metal base layer so as to contact with the metal base layer; and
depositing a magnetic recording layer that is made of ordered alloy having an L1₀-type structure on the orientation control layer so as to contact with the orientation control layer, wherein
the metal base layer has a face-centered cubic structure.

5. The method for manufacturing a magnetic recording medium according to claim 4, wherein the metal base layer is structured using one selected from Ag, Al, Au, Cu, Ir, Ni, Pt, Pd, and Rh, or alloy containing one or more selected from them.

6. The method for manufacturing a magnetic recording medium according to claim 4, wherein a main component of the orientation control layer is MgO.

7. The magnetic recording medium according to claim 1, wherein the metal base layer is made of Pd.

8. The method for manufacturing a magnetic recording medium according to claim 4, wherein the metal base layer is made of Pd.
